(19) United States
(12) Patent Application Publication
(10) Pub. No.: US 2014/0334448 A1
(43) Pub. Date: Nov. 13, 2014

(54) Support of Switching TTI Bundling On/Off

(71) Applicant: Telefonaktiebolaget L M Ericsson (publ), Stockholm (SE)

(72) Inventors: Alexander Langereis, Sigtuna (SE); Ingrid Nordstrand, Sundbyberg (SE); David Sandberg, Solna (SE); Tobias Tynderfeldt, Solna (SE)

(21) Appl. No.: 14/372,119

(22) PCT Filed: Oct. 5, 2012
(86) PCT No.: PCT/SE2012/051068

§ 371 Date: Jul. 14, 2014

Related U.S. Application Data
(60) Provisional application No. 61/587,289, filed on Jan. 17, 2012.

(51) Int. Cl. H04W 36/00

(52) U.S. Cl. CPC H04W 36/0072
USPC 370/331

(57) ABSTRACT

Network Node, NN, (500, 202, 302) and User Equipment, UE, (700, 201, 301) and methods therein, for changing a state of transmission time interval, TTI, Bundling. The method in a NN involves determining whether a transmission time interval, TTI, Bundling setting of the UE should be changed from one state to the other of a state ON and a state OFF. When it is decided (402) that the TTI Bundling setting of the UE should be changed, a message is transmitted to the UE, indicating the decided change of TTI Bundling setting. Further, as a consequence of the decision to change the TTI Bundling setting, and in association with the transmission of the message, mobility control information is transmitted to the UE, indicating the cell A as target cell, in order to cause the UE to perform an intra-cell hand over procedure.

### TECHNICAL FIELD

The herein described technology relates to TTI Bundling, and especially to situations where TTI Bundling settings are to be changed from one state to the other.

### BACKGROUND

Cellular communication networks evolve towards higher data rates, together with improved capacity and coverage. In the 3rd Generation Partnership Project (3GPP) standardization body technologies like GSM, HSPA and LTE have been and are currently developed.

LTE is the latest technology standardised. It uses an access technology based on OFDM (Orthogonal Frequency Division Multiplexing) for the downlink (DL) and Single Carrier FDMA (SC-FDMA) for the uplink (UL). The resource allocation to user equipments (UEs) on both DL and UL is performed adaptively by the concept of fast scheduling, taking into account the instantaneous traffic pattern and radio propagation characteristics of each UE. Assigning resources in both DL and UL is performed in the scheduler situated in the eNodeB (eNB).

In LTE, all packets are delivered using the IP protocol. This means that also traditionally circuit switched services, such as voice conversation will make use of fast scheduling. This is called Voice over IP (VoIP). 3GPP has standardized a mechanism called TTI Bundling specifically for UEs using VoIP while they are limited by their transmission power to the extent that they need to segment their IP packets.

Such segmenting involves splitting of a VoIP packet into a number of segments, which are transmitted over the air interface individually. Since each segment is smaller than the complete VoIP packet, each segment can be transmitted with a larger success probability than the complete VoIP packet. However, since every segment needs its own control information in a header, such as a Radio Link Control and a Medium Access Control header, the transmission of many small segments will result in increased overhead, and thereby decreased system capacity. Also, load on control channels will increase since smaller scheduling units mean that more scheduling needs to be performed and every segment requires a new control message, e.g. a Packet Data Control Channel message.

Transmission Time Interval (TTI) bundling is an alternative to segmenting, and has been standardized in the 3GPP for e.g. UMTS and LTE. A TTI is generally a duration of time for a transmission over an air interface. Especially, TTI relates to encapsulation of higher layer data into frames and further into packets for transmission on the radio link layer.

When TTI Bundling is used for a UE, the same (complete) VoIP packet is transmitted in four consecutive TTIs. The receiver can then combine the information from the four received TTIs using a Hybrid Automatic Repeat Request (HARQ) mechanism and get effectively four times the received energy for the same VoIP packet. With this increase in received energy, the VoIP packet can be received without e.g. extensive retransmission or segmentation, and thus enabling e.g. a decreased packet delay. TTI bundling may also be referred to as “subframe bundling” in some 3GPP specifications.

However, it is not favorable to let UEs, which do not need to segment their packets, use TTI Bundling, since for such UEs, TTI Bundling causes a four times increased UL-SCH usage. Thus, in realistic scenarios there will be a mixture of UE's using TTI Bundling and UE's not using TTI Bundling.

When a UE is configured for TTI Bundling the eNB needs to take into account that the UE will utilize the grant for transmission on four consecutive TTI's. If the configurations of the eNB and the UE with regard to TTI Bundling are not equal or corresponding, the UL-SCH (UpLink-Shared CHannel) transmissions will not succeed.

The UE is configured via RRC (Radio Resource Control) to use or not use TTI Bundling (see e.g. 3GPP 36.331). The RRC parameter ttiBundling is a boolean, which when set to “TRUE” means that TTI Bundling is activated. RRC messages are structured in information elements (IE). The RRC parameter ttiBundling is part of the IE MAC-MainConfig, which in turn is part of the IE RadioResourceConfigDedicated, which in turn can be part of the 3 RRC messages: RRCConnectionSetup, RRCConnectionReestablishment and RRCConnectionReconfiguration:

RRCConnectionSetup
RRCConnectionReestablishment
RRCConnectionReconfiguration

RadioResourceConfigDedicated

MAC-MainConfig

ttiBundling

At reception of an RRCConnectionReconfiguration the UE shall configure its radio resources according to the RRC message and transmit an RRCConnectionReconfigurationComplete using the new configuration.

An RRCConnectionReconfiguration will result in an RRC reconfiguration of the UE and this procedure is ended when an RRCConnectionReconfigurationComplete is received by the eNB.

However, as realized by the inventors, the procedure described above is associated with some problems. For example, when the RRC configuration of a UE needs to be changed, an RRCConnectionReconfiguration message is send to the UE by an eNB. After reception of the RRCConnectionReconfiguration message, the UE will configure its RRC parameters according to the message contents and confirm the reconfiguration by sending an RRCConnectionReconfigurationComplete to the eNB. The UE is required to send the RRCConnectionReconfigurationComplete using the new configuration, but data received prior to the reconfiguration will not be transmitted according to the new configuration.

In the present context the RRC parameter ttiBundling is of particular interest. At some point in time between the reception of an RRCConnectionReconfiguration message and the transmission of an RRCConnectionReconfigurationComplete message, the UE is effectively configured according to the value of ttiBundling, as received in the RRCConnectionReconfiguration message. However, at any time, the UE may need to request UL-SCH resources for transmission of data that is not related to the RRC reconfiguration. When having received the RRCConnectionReconfiguration message and performed the RRC reconfiguration, the UE will request UL-SCH resources to send the RRC reconfiguration confirm message. For either of the two requests, the UE may either transmit a scheduling request (SR) or start a Random Access (RA) procedure to indicate to the eNB that it needs UL-SCH resources. Consequently after the transmission of an RRC connection reconfiguration request message to the UE, it is not possible for the eNB to know whether a request for resources/grant to transmit, which is received from the UE, is related to the transmission of the RRCConnectionReconfigurationComplete message or the transmission of any other data. The UE is required to send the RRCConnectionReconfigurationComplete using the new configuration, but data received prior to the reconfiguration will not be transmitted according to the new configuration. Therefore the eNB cannot know if the UE will use TTI Bundling or not for the UL transmission in response to the admitted resources/grant to transmit.

### SUMMARY

In one of its aspects, the technology disclosed herein provides a set of rules and signaling means to ensure that a UE and a network node serving the UE are in agreement on the configuration to be used for a transmission from the UE to the network node in certain situations. More particularly, embodiments of the technology and concept described herein involve switching TTI Bundling on/off by use of an intra-cell handover using CBRA or CFRA

The advantages of the described concept include at least the following:

It may be exactly known and predictable when a UE is configured for TTI Bundling and when the new configuration will be used for an UL-SCH transmission after a reconfiguration of TTI bundling. This will avoid the loss of UL-SCH transmissions directly after a reconfiguration of TTI bundling, which may appear due to a mismatch of the TTI bundling configuration of the eNB and the UE.

Further, an unclarity in the 3GPP specification about the RRC configuration during a handover of when to start using TTI bundling using CFRA may be resolved. This will enable CFRA usage during all sorts of handover in systems utilizing TTI bundling.

According to a first aspect, a procedure is provided in a radio network node. The procedure comprises indicating a change of TTI Bundling settings (on or off) to a UE, and transmitting mobility control information to the UE, thus causing the UE to initiate a Random Access procedure towards the network node as part of an intra-cell hand over. The method may further comprise receiving a Random Access request from the UE and transmitting a corresponding Random Access response to the UE. The method may further comprise receiving the first transmission from the UE following the Random Access response, in accordance with the type of Random Access procedure used.

According to a second aspect, a network node is provided. The network node is operable to serve a UE in a cell A. The network node comprises a functional unit, adapted to determine whether a transmission time interval, TTI, Bundling setting of the UE should be changed from one state to the other of a state ON and a state OFF. The network node further comprises a functional unit, adapted to transmit a message to the UE when it is decided that the TTI Bundling setting of the UE should be changed, said message indicating the decided change of TTI Bundling setting, and a functional unit adapted to transmit mobility control information to the UE, as a consequence of the decision to change the TTI Bundling setting and in association with the transmission of the message. The mobility control information indicates the cell A as target cell, in order to cause the UE to perform an intra cell hand over procedure

According to a third aspect, a procedure in a UE is provided. The UE is served by a network node in a cell A. The procedure comprises receiving a message from the network node indicating that a Transmission Time Interval, TTI, Bundling setting of the UE should be changed from one state to the other of a state ON and a state OFF. The procedure further comprises determining whether mobility control information is received in association with the message, said mobility control information indicating the cell A as target cell. The procedure further comprising determining which type of Random Access to be used for the Random Access procedure towards the target cell, and applying TTI Bundling setting to transmissions to the network node in accordance with the determined Random Access procedure.

According to a third aspect, a UE is provided, which is operable to be served by a network node in a cell A. The UE comprises a functional unit adapted to receive a message from the network node indicating that a TTI Bundling setting of the UE should be changed from one state to the other of a state ON and a state OFF. The UE further comprises a functional unit adapted to determine whether mobility control information is received in association with the message, said mobility control information indicating the cell A as target cell. The UE further comprises a functional unit adapted to determine which type of Random Access to be used for the Random Access procedure towards the target cell, and a functional unit, adapted to apply TTI Bundling setting to transmissions to the network node in accordance with the determined Random Access procedure.

In further aspects, computer programs and computer program products are provided, which may be comprised in the UE or the network node, respectively, to enable said UE and network node to perform the respective procedures described above.

### BRIEF DESCRIPTION OF THE DRAWINGS

The foregoing and other objects, features, and advantages of the technology disclosed herein will be apparent from the following more particular description of embodiments as illustrated in the accompanying drawings. The drawings are not necessarily to scale, emphasis instead being placed upon illustrating the principles of the technology disclosed herein.

FIG. 1 shows a problem case in the prior art: After the RRC Reconfiguration Request 1:1 to configure the UE for TTI Bundling, the UE receives data in its buffer 1:11 prior to the instance where the RRC Reconfiguration becomes effective 1:12. In the illustrated case, the eNB cannot know if the UL-SCH resource requested by the SR 1:2 will use TTI Bundling or not.

FIG. 2a shows an exemplifying scenario in a cell, where an exemplifying embodiment could be applied.

FIG. 2b shows an example of the use of an intra-cell handover to switch TTI Bundling ON for a UE using CBRA, according to an exemplifying embodiment.

FIGS. 3a and 3b show examples of the use of an intra-cell handover to switch TTI Bundling ON for a UE using CFRA, according to exemplifying embodiments.

FIGS. 4a, 4b and 4c show flow charts of a TTI Bundling reconfiguration procedure using intra-cell handover with CBRA and CFRA, respectively, according to exemplifying embodiments.

FIG. 4d is a flow chart illustrating a generalized TTI Bundling reconfiguration procedure using intra-cell handover according to an exemplifying embodiment.

FIG. 5 is a block chart, illustrating an arrangement 501 in a network node 500, according to an exemplifying embodiment.

FIG. 6 and is a flow chart illustrating a TTI Bundling reconfiguration procedure using intra-cell handover, in a UE, according to an exemplifying embodiment.

FIG. 7 is a block chart, illustrating an arrangement 701 in a UE 700, according to an exemplifying embodiment.

FIGS. 8-9 are block charts illustrating arrangements according to exemplifying embodiments.

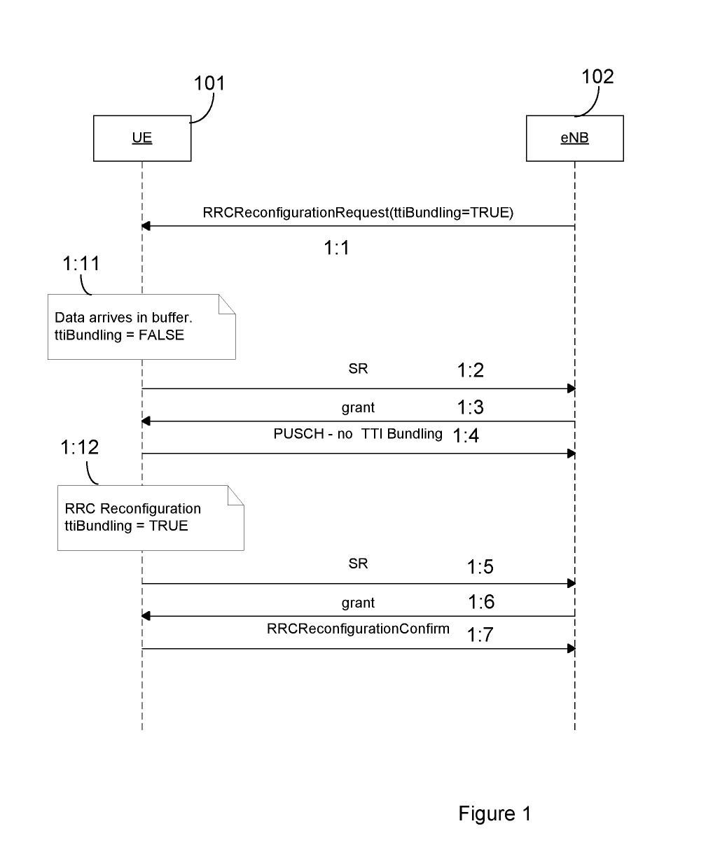

### DETAILED DESCRIPTION

In the following description, for purposes of explanation and not limitation, specific details are set forth such as particular architectures, interfaces, techniques, etc. in order to provide a thorough understanding of the concept described herein. However, it will be apparent to those skilled in the art that the described concept may be practiced in other embodiments that depart from these specific details. That is, those skilled in the art will be able to devise various arrangements which, although not explicitly described or shown herein, embody the principles of the described concept and are included within its scope. In some instances, detailed descriptions of well-known devices, circuits, and methods are omitted so as not to obscure the description according to the present concept with unnecessary detail. All statements herein reciting principles, aspects, and embodiments of the described concept, as well as specific examples thereof, are intended to encompass both structural and functional equivalents thereof. Additionally, it is intended that such equivalents include both currently known equivalents as well as equivalents developed in the future, e.g., any elements developed that perform the same function, regardless of structure.

Thus, for example, it will be appreciated by those skilled in the art that block diagrams herein can represent conceptual views of illustrative circuitry or other functional units embodying the principles of the technology. Similarly, it will be appreciated that any flow charts, state transition diagrams, pseudocode, and the like represent various processes which may be substantially represented in computer readable medium and so executed by a computer or processor, whether or not such computer or processor is explicitly shown.

The functions of the various elements including functional blocks, including but not limited to those labeled or described as e.g. “computer”, “processor” or “controller”, may be provided through the use of hardware such as circuit hardware and/or hardware capable of executing software in the form of coded instructions stored on computer readable medium. Thus, such functions and illustrated functional blocks are to be understood as being either hardware-implemented and/or computer-implemented, and thus machine-implemented.

In terms of hardware implementation, the functional blocks may include or encompass, without limitation, digital signal processor (DSP) hardware, reduced instruction set processor, hardware, e.g., digital or analog circuitry including, but not limited to, Application Specific Integrated Circuit(s) (ASICs), and where appropriate, state machines capable of performing such functions.

For the configuration of TTI Bundling, it is in this document suggested that, instead of sending an RRC connection reconfiguration message, e.g. RRCConnectionReconfiguration, not comprising mobility control information, the eNB may send an RRC connection reconfiguration message comprising mobility control information, where the mobility control information may specify that the target cell is equal to the source cell. This will result in an intra-cell handover. After reception of the RRC connection reconfiguration message comprising mobility control information, the UE will start a Random Access procedure, which may be either contention free (CFRA) or contention based (CBRA). During a Random Access procedure, a unique identity in the cell is assigned to the UE, in form of a Cell Radio Network Temporary Identifier (C-RNTI).

An RRCConnectionReconfiguration that includes the IE mobilityControlInfo will result in a MAC reset and the UE will do a handover to the cell specified in the mobilityControlInfo. To synchronize its uplink timing and connect to the target cell the UE will do a Random Access (RA) in the target cell. The Random Access can be either a CFRA or a CBRA.

A CFRA procedure is initiated by the network, i.e. not the UE, and uses a dedicated Random Access preamble code, which is allocated to the UE for a limited period of time. The dedicated preamble code is provided to the UE for use in a Random Access request.

A CBRA procedure is initiated by the UE to gain access to the network. It involves selecting a Random Access preamble code from a list of codes available for selection by all UEs in a cell. The CBRA requires additional signaling, as compared to CFRA, in order to resolve contention that may occur when multiple UEs attempt to access the cell (that is, access the network node serving the cell) in the same PRACH subframe using the same preamble code.

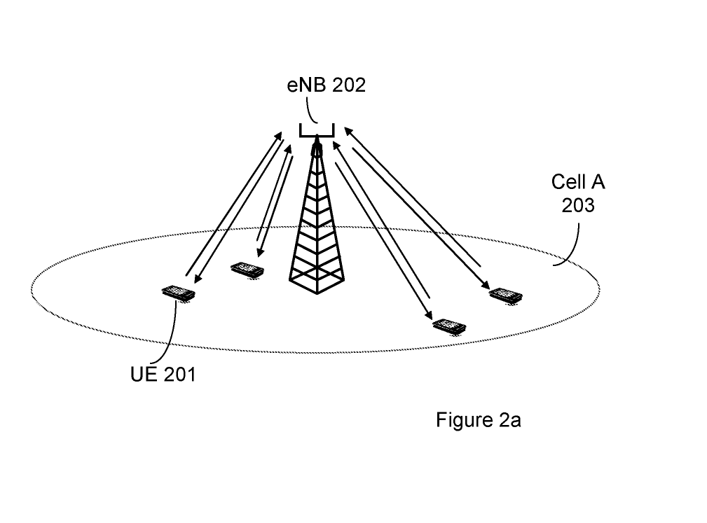

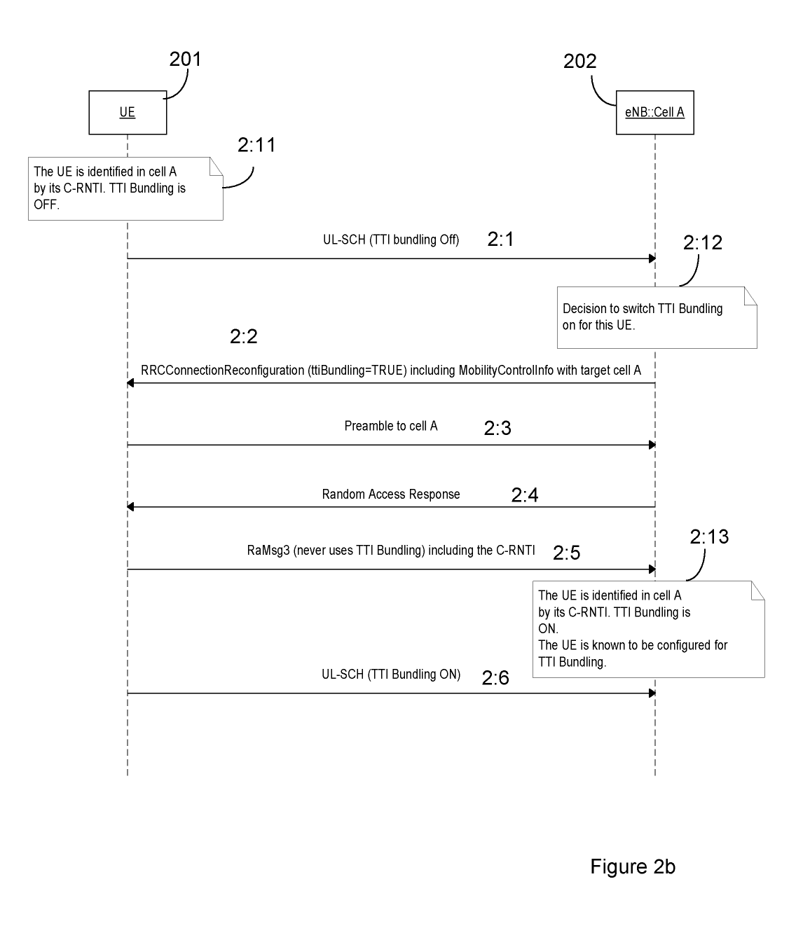

In case of CBRA, it is clear, e.g. from 3GPP 36.321, that the so-called “Message 3” sent by the UE, i.e. the message acknowledging the Random Access Response in the CBRA procedure, will be sent without using TTI Bundling. It is further clear that the UE will include its C-RNTI in this Message 3. Thus, when the eNB identifies the UE by its C-RNTI, the eNB may conclude that the RRC reconfiguration has been concluded successfully and that UL-SCH transmissions after Message 3 will be performed according to the new TTI Bundling configuration, see FIG. 2.

FIG. 2b shows an exemplifying signaling scheme between a UE 201 and an eNB 202 associated with a cell A, illustrated in FIG. 2a as “Cell A” 203. FIG. 2b illustrates a procedure for changing TTI Bundling settings for the UE from off (deactivated) to on (activated) involving the use of CBRA. The initial situation in the example illustrated in FIG. 2 is that the UE is identified in cell A by its C-RNTI, and TTI Bundling is off (deactivated) for the UE, which is illustrated as the state 2:11. At some point, upon receiving a communication 2:1 from the UE, the eNB decides 2:12 that TTI Bundling should be switched on (activated) for the UE. The eNB sends a reconfiguration message 2:2 to the UE, including mobility control information identifying cell A as target cell. Thereby, eNB 202 is indirectly indicated as target node. The UE initiates an intra-cell handover by initiating a Random Access procedure by sending a preamble 2:3 to the base station associated with cell A, which in this example is the eNB 202. The eNB 202 sends a Random Access response 2:4 to the UE 201, which responds with a Message 3 (RaMsg3) 2:5, comprising the C-RNTI of the UE. As previously mentioned, TTI Bundling is not used in Message 3. Thus, the UE 201 is identified (by the eNB 202) in cell A by its C-RNTI and the eNB 202 is aware of that the UE 201 has been configured for (active) TTI Bundling, which is illustrated as action 2:13. The UE 201 has in the meantime activated TTI Bundling. Thus, the eNB 202 expects that TTI Bundling will be applied for a communication 2:6 from the UE, following the Message 3 2:5.

The use of the procedure described above solves the problem of resolving in which transmission from a UE a new TTI Bundling setting will be applied, when CBRA is used. However, as realized by the inventors, another problem occurs if the UE is to be configured to change its TTI bundling setting as above, but is to use CFRA for performing the intra cell handover. It is not described in the 3GPP specifications if TTI bundling shall be applied on the UL-SCH transmission granted by the Random Access response message in case of CFRA. It is stated that TTI bundling shall not be applied to the so-called Random Access “Message 3” (or “Msg 3” or “RaMsg3”), but, for CFRA, no “Message 3” exists. In CFRA, the UE considers the Random Access procedure to be successfully completed when it receives a Random Access response message containing the Random Access preamble identifier corresponding to the dedicated preamble that was used during the procedure. Additionally, it is stated in 3GPP 36.213 that an UL-SCH transport block shall be transmitted in the first subframe n+k_{—}1 with k_{—}1>=6, as a response to the Random Access response message indicating that TTI bundling cannot be applied on this UL-SCH transmission. Thus, it is clear that TTI Bundling is not even considered, and nothing is mentioned on that transmission in case of CFRA. Thus, it is unclear:
Whether TTI bundling shall be applied on the UL-SCH transmission granted by the Random Access response message in the CFRA procedure.
If it is possible to use CFRA in a handover procedure when a UE is to be configured to activate or deactivate TTI bundling.

That is, in case CFRA is used, there is no Message 3, and it is therefore not clear if TTI bundling may or will be applied on the UL-SCH transmission granted by the Random Access response message. This problem may be resolved, according to the inventors, in different ways, such as:

Solution 1: It could be stipulated that TTI bundling should not be applied on the UL-SCH transmission granted by a Random Access Response message during CFRA. In order to regulate this solution, a clarification may be added e.g. to 3GPP TS 36.321, e.g. by adding a condition according to the following underlined text (non underlined text within citation marks taken from TS 36.321): “For transmission of Msg3 during Random Access (see section 5.1.5) and the UL-SCH transmission granted by the Random Access Response message during contention free Random Access, TTI bundling does not apply”.

Solution 2: It could be stipulated how the UE shall use the uplink grant received in the Random Access response message if the UE is configured for TTI bundling. For example, it may be stipulated that the UE should apply the new configured or changed TTI Bundling setting on the transmission granted by the uplink grant.

In order to regulate this solution, for example, a condition according to the following underlined text may be added in 3GPP TS 36.213 V10.3.0, section 6.1.1, point “a”:
a. “If a PDCCH with associated RA-RNTI is detected in subframe n, and the corresponding DL-SCH transport block contains a response to the transmitted preamble sequence, the UE shall, according to the information in the response,
   i. for normal HARQ operation the UE shall transmit an UL-SCH transport block in the first subframe n+k₁, k₁≧6 , if the UL delay field in section 6.2 is set to zero where n+k₁ is the first available UL subframe for PUSCH transmission.
   ii. for subframe bundling operation (TTI Bundling) the UE shall start to transmit the bundle with an UL-SCH transport block in the first subframe n+k₁, k₁24 6, if the UL delay field in section 6.2 is set to zero where n+k₁ is the first available UL subframe for PUSCH transmission. The UE shall postpone the start of bundled PUSCH transmission to the next available UL subframe after n+k₁ if the field is set to 1.
b. If a Random Access response is received in subframe n, and the corresponding DL-SCH transport block does not contain a response to the transmitted preamble sequence, the UE shall, if requested by higher layers, be ready to transmit a new preamble sequence no later than in subframe n+5.
c. If no Random Access response is received in subframe n, where subframe n is the last subframe of the Random Access response window, the UE shall, if requested by higher layers, be ready to transmit a new preamble sequence no later than in subframe n+4 .

In case a Random Access procedure is initiated by a PDCCH order in subframe n, the UE shall, if requested by higher layers, transmit Random Access preamble in the first subframe n+k₂, k₂≧6 , where a PRACH resource is available.”

When an eNB decides that a UE shall switch TTI Bundling on or off, an RRC connection reconfiguration message comprising mobility control information may be sent to the UE. The target cell indicated in the mobility control information is the cell to which the UE is already connected. When the UE receives an RRC connection reconfiguration message comprising mobility control information, the UE will start a Random Access procedure in order to connect to the target cell indicated in the mobility control information. When the target cell is equal to the source cell, the result will be an intra-cell handover, see e.g. FIG. 2.

The Random Access procedure initiated by the UE may be either a CFRA procedure or a CBRA procedure, as previously described. For CBRA, the 3GPP specification 36.321 specifies that RaMsg3 is excluded from TTI Bundling. The RaMsg3 includes the UE's C-RNTI and is used to determine that the Random Access has been concluded from the eNB point of view. The time from sending the preamble to identification of the UE depends on several factors and the maximum waiting time shall be set with a timer in the eNB. When the timer expires the procedure shall be repeated until this has been done a maximum number of times. All uplink UL-SCH transmissions after RaMsg3 will be done according to the new configuration.

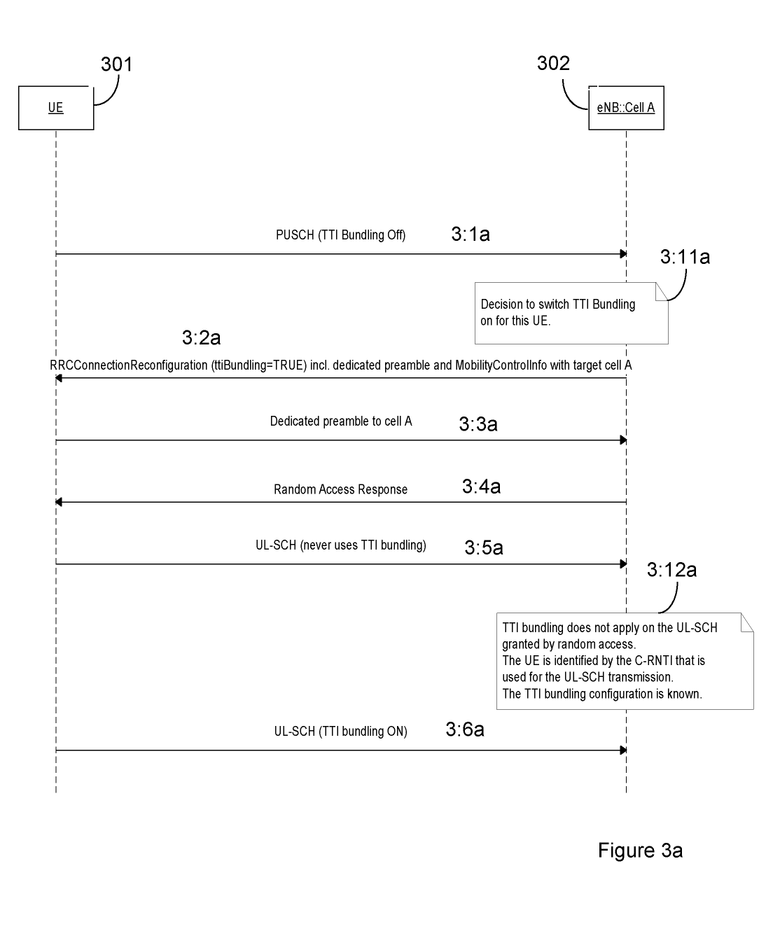

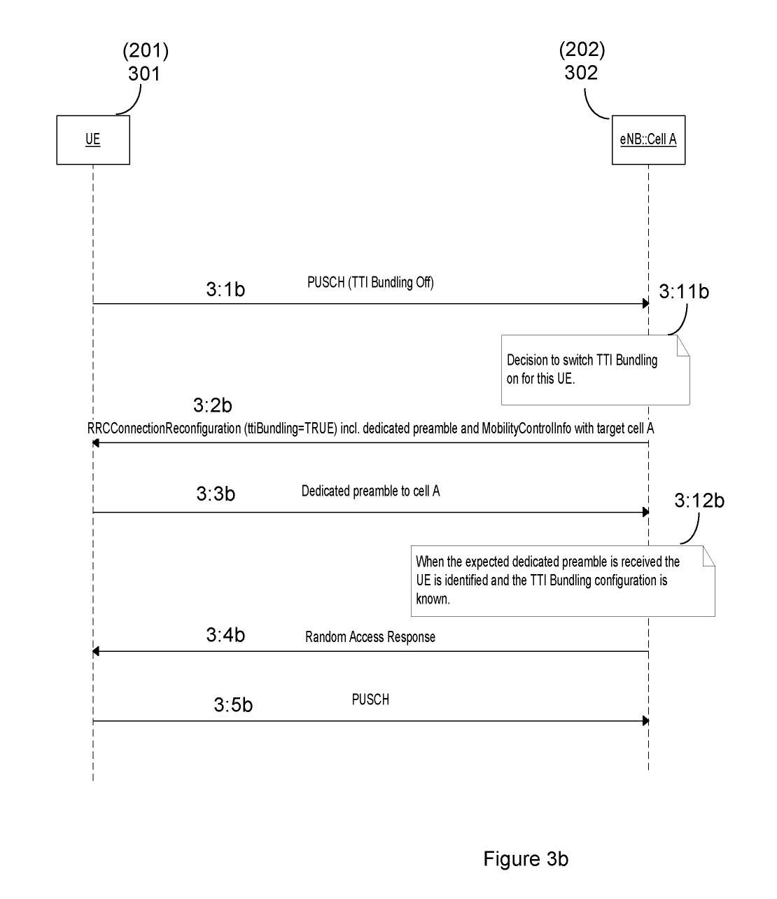

As previously mentioned, for CFRA, there is no Msg3 and the 3GPP specifications are unclear on how to apply TTI Bundling. However, e.g. Solution 1, as described above may be applied. When applying Solution 1, the eNB identifies the UE by detecting the C-RNTI associated with the transmission on the UL-SCH resources that were granted by the Random Access response message. According to Solution 1, TTI Bundling shall not be used on the transmission following a Random Access response message. This is illustrated e.g. in FIG. 3a, where the transmission 3:5a, following the Random Access response 3:4a, is send without TTI Bundling, irrespective of whether TTI Bundling is active or inactive. The nodes, transmissions and actions in FIG. 3a may otherwise be considered to correspond to those illustrated in FIG. 2. Further, a waiting time may be set with a timer in the eNB. If the timer expires the procedure may be repeated up to a maximum number of times. After identification of the UE, the eNB assumes that the UL-SCH resources granted by the Random Access response message are transmitted according to the TTI bundling configuration specified by the handover preparation message (reconfiguration message).

A procedure where CFRA according to Solution 2 is used is illustrated in FIG. 3b. When it is determined in the eNB 302 that the TTI Bundling settings for a UE should be changed, an indication, such as an RRCConnectionReconfiguration message 3:2b is sent to the UE. The indication or message indicates or comprises the new settings and further indicates or comprises mobility control information as previously described in conjunction with FIGS. 2 and 3a. However, in case of CFRA, this indication or message further comprises a dedicated preamble to be used in the Random Access procedure. When the dedicated preamble is used in a Random Access request 3:3b, the eNB may identify the UE based on the dedicated preamble, and thus conclude that the UE is reconfigured to the new TTI Bundling settings. The eNB sends a Random Access response 3:4b granting an uplink transmission 3:5b. The uplink transmission 3:5b is then transmitted and received in accordance with the new TTI Bundling settings indicated in the indication or message 3:2b.

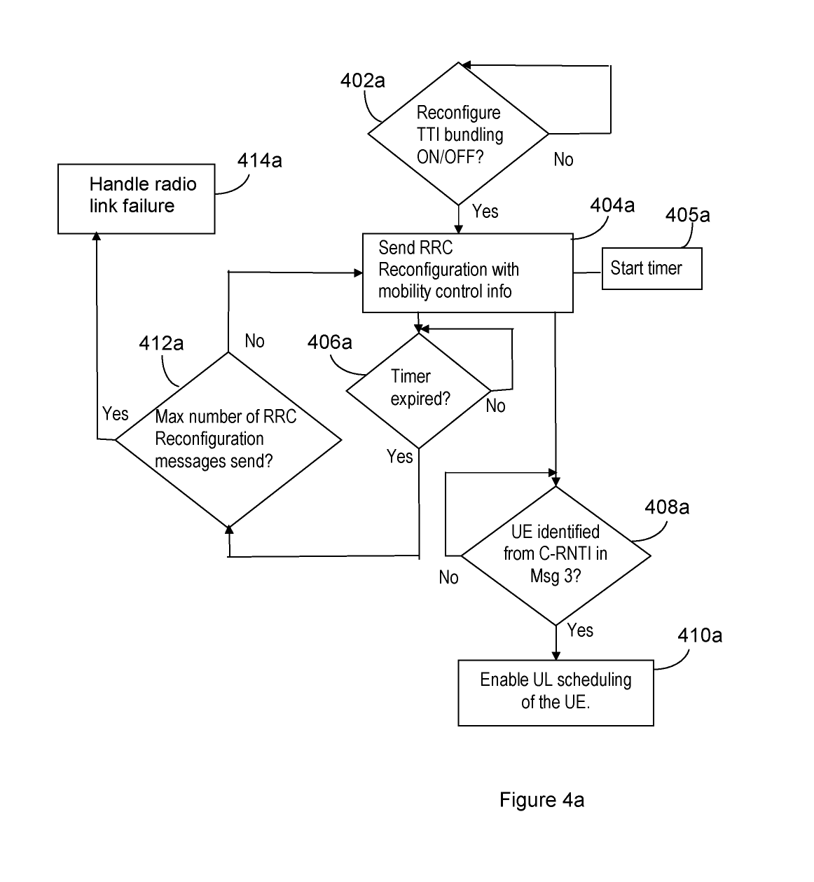

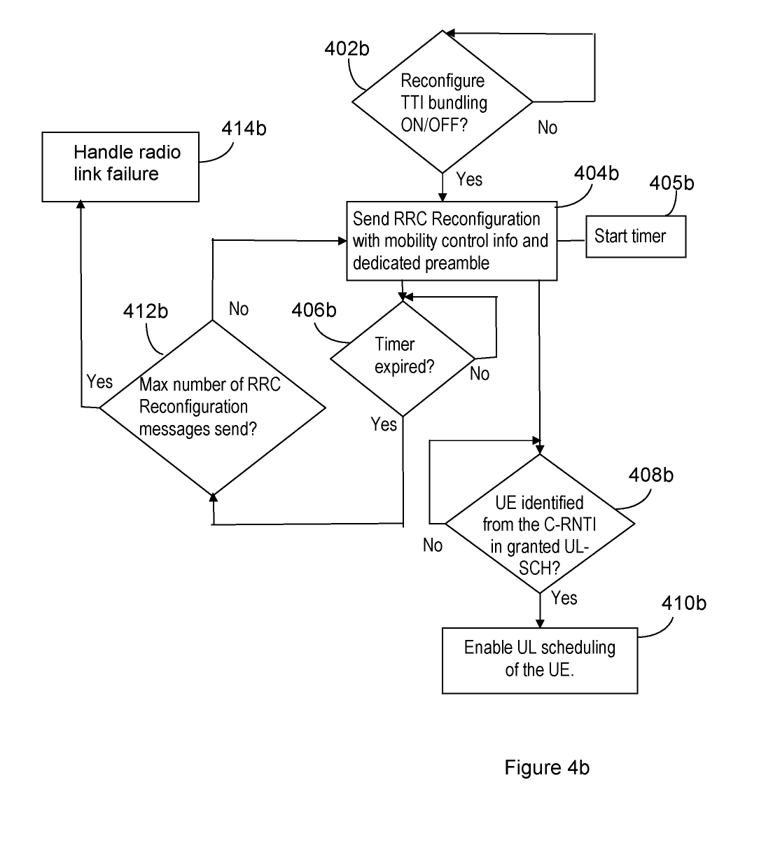

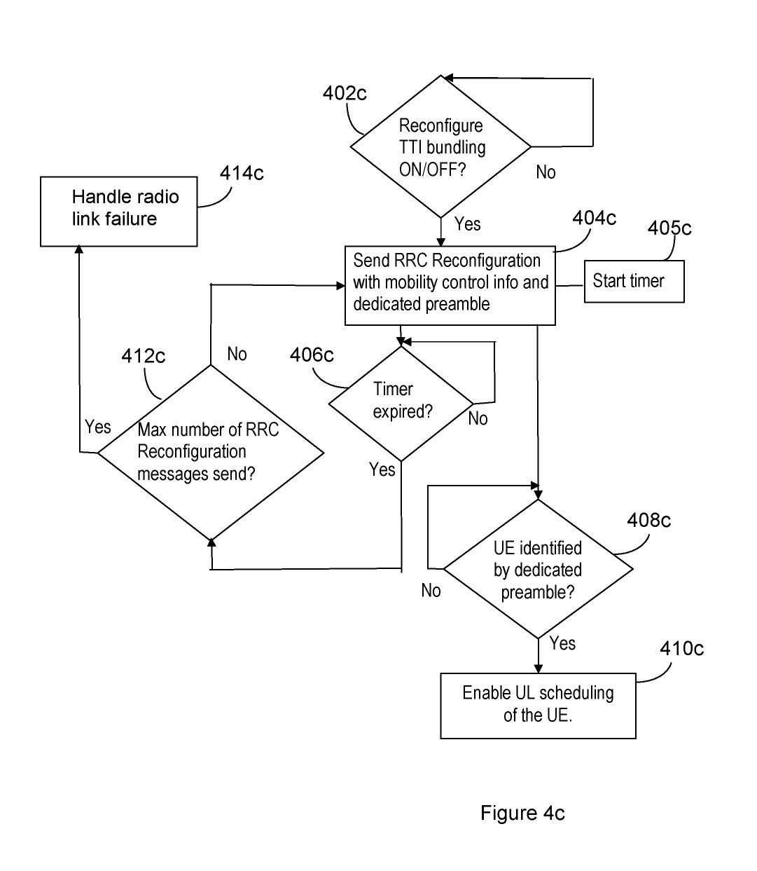

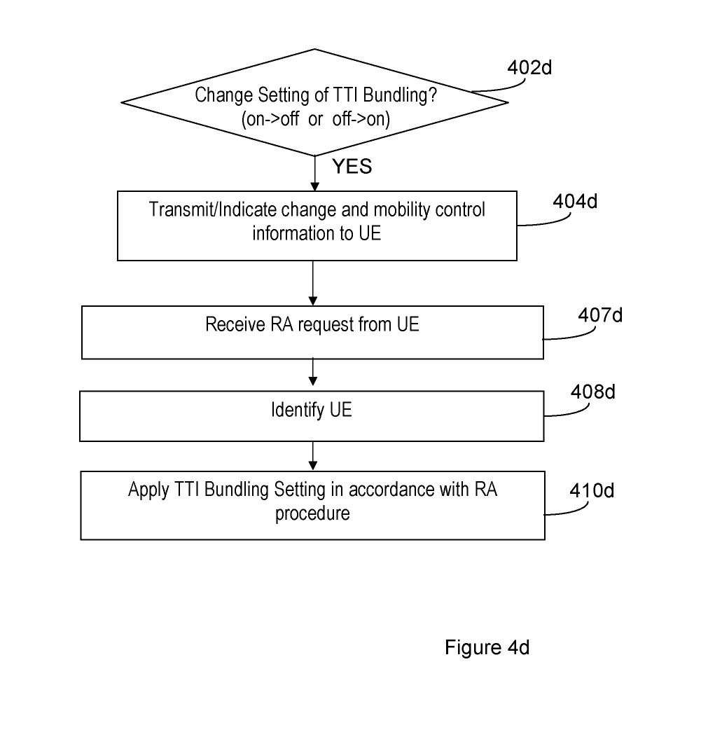

Exemplifying procedures in a network node, such as an eNB in an LTE-type system, serving a UE, will be described with reference to FIGS. 4a and 4b. The procedure in FIG. 4a illustrates a case where CBRA is used, and the procedures in FIGS. 4b and 4c illustrate cases where CFRA is used according to the previously described Solution 1 and Solution 2, respectively.

In FIG. 4a (CBRA), it is determined in an action 402a whether TTI Bundling settings for a UE should be changed, or reconfigured, from one state to another, i.e. from on to off or vice versa. When it is determined in action 402a that the settings should be changed, an RRC Reconfiguration message comprising mobility control information is sent to the UE in an action 404a. Further, a timer may be set in an action 405a. It may be determined in an action 408a whether the UE has been identified from Message 3 in the CBRA Random Access procedure. If the UE has been identified from Message 3 following the Random Access response, the TTI Bundling settings of the UE may be considered to be known and to be in accordance with the settings in the previously sent RRC Reconfiguration message, and scheduling of the UE may be enabled, e.g. in an action 410a. When the UE is identified e.g. in action 408a, the timer function may be cancelled.

If the UE has not been identified e.g. in action 408a, and it is determined e.g. in an action 412a that the timer has expired, it may be determined in an action 412a whether a maximum number of RRC Reconfiguration messages have been sent or not. If not, another RRC Reconfiguration message may be sent, e.g. in an action 404a, another timer be started in action 405a, and so forth. If a maximum number of RRC Reconfiguration messages have been sent, a radio link failure may be handled in an action 414a.

FIG. 4b (CFRA, Solution 1) comprises corresponding actions as FIG. 4a, with the difference that in action 404b, a dedicated preamble is transmitted to the UE, for use in a CFRA procedure towards the target cell and thus the network node. A further difference is that it is determined in an action 408b whether the UE has been identified from a transmission granted by and following a CFRA Random Access response, i.e. a message other than “Message 3”, since no Message 3 exists in CFRA.

FIG. 4c illustrates a procedure where CFRA is used according to the previously described Solution 2. All actions in FIG. 4c, except actions 404c and 408c, may be regarded as corresponding to what has previously been described in conjunction with FIG. 4a. Here, in action 404c, as in 404b, an RRC Reconfiguration message is sent, which comprises mobility control info, inducing an intra cell handover, and further comprises a dedicated preamble for use in a CFRA procedure towards the network node. In action 408c, the UE may then be identified already from the Random Access request, due to the known dedicated preamble. Thus, the message following the Random Access response may be sent in accordance with the configuration specified in the RRC Reconfiguration message.

More than one of the procedures could be implemented in a network node, e.g. by determining in an action 408a, b or c whether the UE has been identified from a message following a CFRA procedure or from a Message 3 in a CBRA procedure. All three procedures or variants thereof could be implemented and enabled in a network node, and the method of preference could be selected e.g. according to some criteria.

FIG. 4d shows a flow chart illustrating a more generalized example of the procedure suggested herein. It is determined in an action 402d, whether TTI Bundling settings for a UE should be changed, i.e. from on to off or vice versa. The determining may be performed e.g. in accordance with standard procedure of today. When it is determined in action 402d that the settings should be changed, the new setting is indicated to the UE in an action 404d, together with mobility control information indicating the serving cell as target cell, and thus indirectly the network node as target node. Mobility control information, typically, identifies a cell as target cell, which could be regarded as an indication of the network node serving said cell as target node. The network node could serve more than one cell, but herein only one cell is discussed, which is both source cell and target cell.

A timer may be set and cancelled as previously described. A Random Access request message is received in an action 407d, where the Random Access request is sent due to the mobility control information indicated to the UE. The UE may then be identified in an action 408d, depending on which type of Random Access procedure that is performed. The TTI Bundling setting may then be applied in a correct manner, which is illustrated as an action 410d. That is, it may be determined for which messages to apply the new TTI Bundling setting, based on the Random Access procedure. This could also be expressed as that it may be determined based on a set of rules associated with the RA procedures

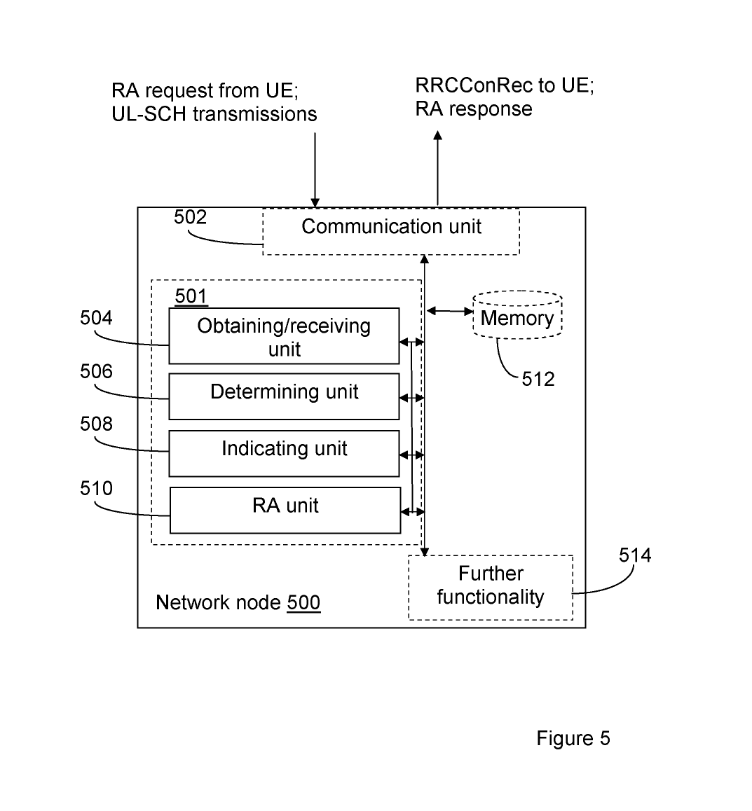

An arrangement according to an exemplifying embodiment of the technology and concept presented in this document will now be described with reference to FIG. 5. The arrangement is illustrated as located in a network node 500, such as e.g. an eNB in an LTE-type system. The arrangement and/or network node are adapted to enable e.g. the performance of one or more of the procedures illustrated in FIGS. 4a-4d. The network node 500 is illustrated as to communicate with other entities via a communication unit 502, which may be considered to comprise conventional means for wireless and/or wired communication, such as one or more transceivers. The arrangement and/or node may further comprise other functional units 514, for providing e.g. regular base station functions, such as e.g. scheduling and other serving of UEs. The arrangement and/or node may further comprise one or more storage units 512.

The arrangement 501 could be implemented e.g. by one or more of: a processor or a micro processor and adequate software and storage therefore, a Programmable Logic Device (PLD) or other electronic component(s)/processing circuit(s) configured to perform the actions mentioned above.

The arrangement 501 may comprise e.g. an obtaining unit 504, adapted e.g. to obtain information related to a UE. The information may be related to the radio conditions of the UE and/or indicate whether the UE is segmenting VoIP packets due to unfavourable radio conditions. The arrangement may further comprise a determining unit 506, adapted to determine whether TTI Bundling should be activated or deactivated for the UE, based on the obtained information. The arrangement comprises an indicating unit 508, which may also be denoted e.g. “transmitting unit”, which is adapted to, if it is determined that TTI Bundling is to be activated or deactivated for the UE, transmit a message indicating the change of TTI Bundling setting to the UE, and further, to indicate mobility control information to the UE. The mobility control information is transmitted as a consequence of the decision to change the TTI Bundling setting, and it is transmitted in association with the transmission of indication related to TTI Bundling activation/deactivation. That is, the mobility control information is not related to a regular hand over, coinciding with the change of TTI-settings, but is used to solve the problem previously described herein.

The indication may be conveyed to the UE by transmitting an RRC connection reconfiguration request message to the UE, which message is arranged to comprise the mobility control information indicating the serving cell as target cell. At least in LTE-type systems, this message is denoted RRCConnectionReconfiguration, but may be denoted differently in other systems or in future versions of LTE.

This may also be described as that the network node initiates a reconfiguration of the TTI Bundling settings of the UE, e.g. by triggering the transmission of an RRC connection reconfiguration request message. And in a preferred solution, the RRC connection reconfiguration request message is arranged to comprise mobility control information identifying the serving cell as target cell, and thus indicating the network node 500 as a handover target node, thus causing the UE to initiate a Random Access procedure towards the network node 500, i.e. initiating an intra cell handover.

The indicating unit could further be adapted to include a dedicated preamble in the RRC connection reconfiguration request message, for use in a CFRA procedure, such as Solution 1 or 2 described above. The arrangement may further comprise an RA unit 510, which may also be denoted e.g. “receiving unit”, which is adapted to receive a Random Access request, e.g. a dedicated preamble or some other preamble, depending on the type of procedure, from the UE and transmit a Random Access response to the UE in response to the request. Further, the arrangement and/or network node may be adapted to receive the transmission, from the UE, which follows after the Random Access response in an appropriate way, e.g. under the assumption that TTI Bundling has not been used for said transmission in case of CFRA Solution 1. Alternatively or in addition, the arrangement and/or network node may be adapted to identify the UE based on the dedicated preamble, when such a dedicated preamble is used in the Random Access request (CFRA), and further be adapted to receive the transmission which follows after the Random Access response in accordance with the TTI Bundling settings in the RRC connection reconfiguration request message, i.e. as described in Solution 2 above.

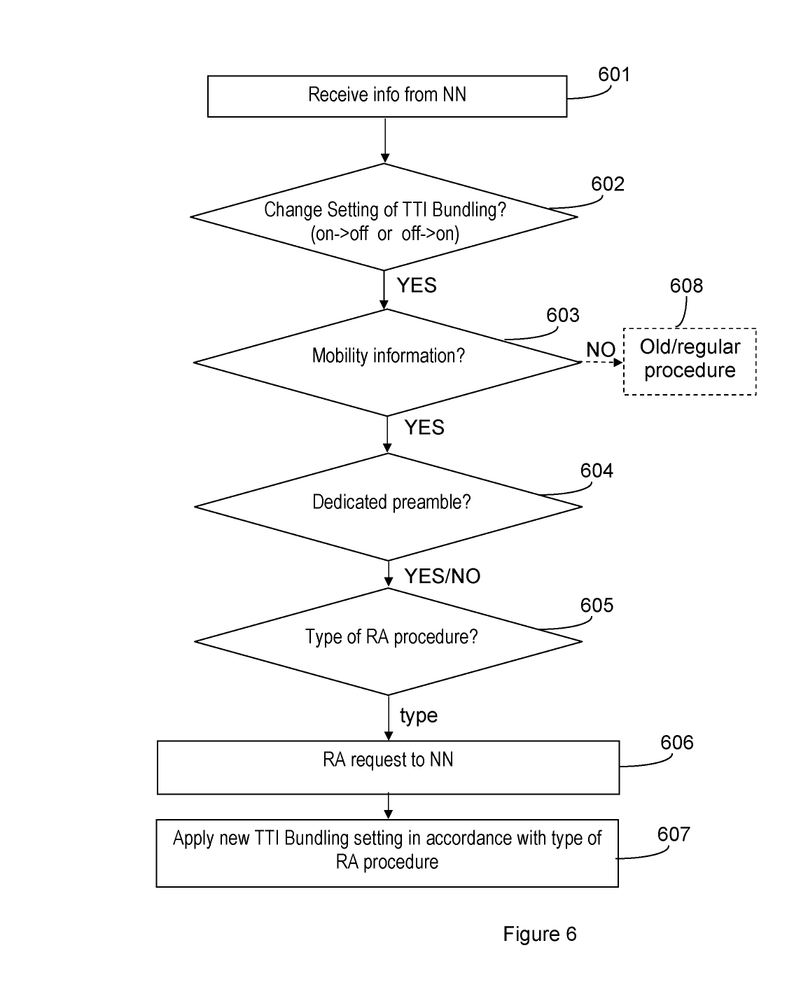

FIG. 6 is exemplifying flow chart illustrating an exemplifying embodiment of the herein suggested procedure in a UE. Information is received from the network node in an action 601. This information may be comprised in an RRCConnectionReconfiguration message. It may be determined in an action 602 whether the received information comprises an indication of that a TTI Bundling setting is to be changed from on to off, or vice versa. Further, it may be determined in an action 603, whether the information comprises mobility control information indicating the serving cell as target cell. If not, the herein suggested technology is not applied, which is illustrated as action 608. It may further be determined in an action 604, whether the information comprises an indication of a dedicated preamble in association with the mobility control information. It may further be determined in an action 605, which type of Random Access procedure that should be initiated, e.g. CBRA, CFRA Solution 1, or CFRA Solution 2, described herein. This may be determined based e.g. on whether a dedicated preamble is received and/or according to a set of rules, a previous agreement or a configuration. Then, a Random Access procedure is initiated in an action 606 by the transmission of an Random Access request. Then, the new setting for TTI Bundling is applied in accordance with the type of Random Access procedure, which is illustrated as an action 607.

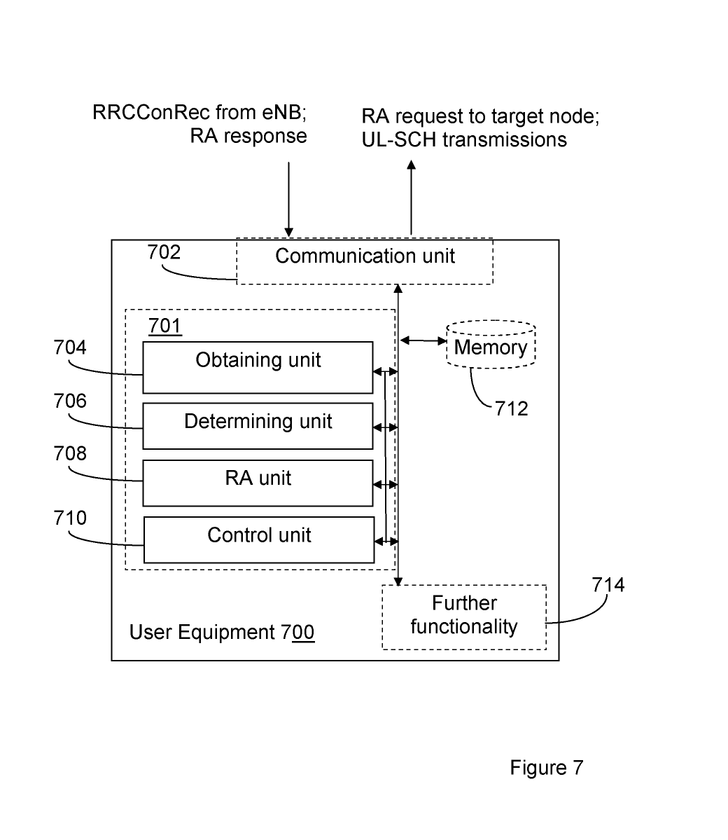

An arrangement according to an exemplifying embodiment will now be described with reference to FIG. 7. The arrangement is illustrated as located in a UE 700, such as e.g. a UE operable in an LTE-type system. The arrangement and possibly other parts of the UE are adapted to enable e.g. the performance of one or more of the procedures in a UE, illustrated in FIGS. 2, 3a-3b and 6. The UE 700 is illustrated as to communicate with other entities via a communication unit 702, which may be considered to comprise conventional means for wireless communication. The arrangement and/or UE may further comprise other functional units 714, for providing e.g. regular UE functions. The arrangement and/or UE may further comprise one or more storage units 712.

The arrangement 701 could be implemented e.g. by one or more of: a processor or a micro processor and adequate software and storage therefore, a Programmable Logic Device (PLD) or other electronic component(s)/processing circuit(s) configured to perform the actions mentioned above.

The arrangement 701 may comprise e.g. an obtaining unit 704, adapted to obtain information related to reconfiguration of the TTI Bundling settings, e.g. receiving an RRC connection reconfiguration request message from a serving network node. The arrangement further comprises a determining unit 706, adapted to determine whether TTI Bundling should be activated or deactivated for the UE based on the obtained information, and whether mobility control information comprising an indication of a target cell is provided in association with the information on reconfiguration. The determining unit may further be adapted to determine whether a dedicated preamble is included in the RRC connection reconfiguration request message.

The arrangement may further comprise an RA unit 708, which is adapted to, when it is determined that TTI Bundling is to be activated or deactivated for the UE, and that a target cell is identified, and thus a target node indicated, initiate a Random Access procedure using e.g. CFRA, by requesting Random Access to the target node. If a dedicated preamble was included in the RRC connection reconfiguration request message, this dedicated preamble could be used for the Random Access request to the target, which is also the serving, network node, the Random Access procedure then being a CFRA procedure. The arrangement may further comprise a control unit 710, adapted to, when a Random Access response is received from the target network node, control the transmission to the target network node following the reception of a Random Access response, such that said transmission is not performed using TTI Bundling in case of CBRA or CFRA Solution 1, or, performed in accordance with the obtained information related to reconfiguration of the TTI Bundling settings in case of CFRA Solution 2.

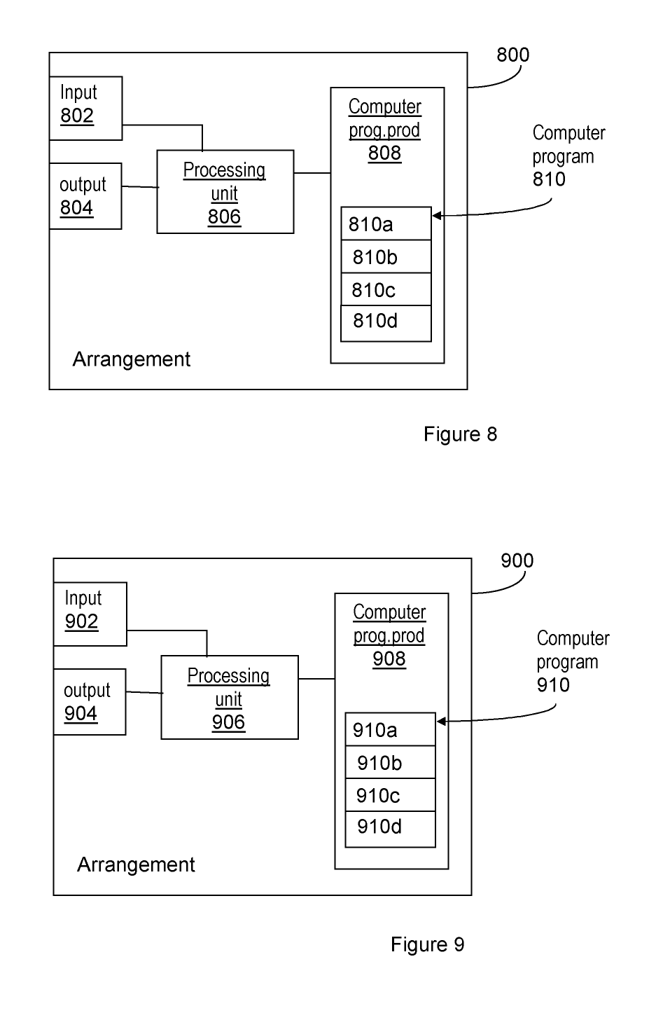

FIG. 8 schematically shows an embodiment of an arrangement 800 for use in a UE, which also can be an alternative way of disclosing an embodiment of the arrangement 701 in a UE illustrated in FIG. 7. Comprised in the arrangement 800 are here a processing unit 806, e.g. with a DSP (Digital Signal Processor). The processing unit 806 may be a single unit or a plurality of units to perform different actions of procedures described herein. The arrangement 800 may also comprise an input unit 802 for receiving signals from other entities, and an output unit 804 for providing signal(s) to other entities. The input unit 802 and the output unit 804 may be arranged as an integrated entity.

Furthermore, the arrangement 800 comprises at least one computer program product 808 in the form of a non-volatile or volatile memory, e.g. an EEPROM (Electrically Erasable Programmable Read-only Memory), a flash memory, a disk drive or a RAM (Random-access memory). The computer program product 808 comprises a computer program 810, which comprises code means, which when executed in the processing unit 806 in the arrangement 800 causes the arrangement and/or the UE to perform the actions of any of the procedures described earlier in conjunction with FIGS. 4a-4d.

The computer program 810 may be configured as a computer program code structured in computer program modules. Hence, in an exemplifying embodiment, the code means in the computer program 810 of the arrangement 800 may comprise an obtaining module 810a for obtaining e.g. receiving TTI Bundling reconfiguration messages. The computer program comprises a determining module 810b for determining which actions to perform in reaction to a received reconfiguration message. The computer program 810 further comprises a Random Access module 810c for, when the reconfiguration message comprises mobility control information, indicating the serving cell as target cell, initiating a Random Access procedure towards the target cell, and thus towards the target node. The computer program 810 could further comprise a control module 810d for control the transmission to the target network node following the reception of a Random Access response, such that said transmission is not performed using TTI Bundling in case of CBRA or CFRA Solution 1, or, performed in accordance with the obtained information related to reconfiguration of the TTI Bundling settings in case of CFRA Solution 2.

The modules 810a-d could essentially perform the actions indicted in FIGS. 2b, 3a-3b and 6, to emulate the arrangement in a UE illustrated in FIG. 7. In other words, when the different modules 810a-d are executed in the processing unit 806, they may correspond to the units 704-710 of FIG. 7.

The processor may be a single CPU (Central processing unit), but could also comprise two or more processing units. For example, the processor may include general purpose microprocessors; instruction set processors and/or related chips sets and/or special purpose microprocessors such as ASICs (Application Specific Integrated Circuit). The processor may also comprise board memory for caching purposes. The computer program may be carried by a computer program product connected to the processor. The computer program product may comprise a computer readable medium on which the computer program is stored. For example, the computer program product may be a flash memory, a RAM (Random-access memory) ROM (Read-Only Memory) or an EEPROM, and the computer program modules described above could in alternative embodiments be distributed on different computer program products in the form of memories within the network node.

In a similar manner, an exemplifying embodiment comprising computer program modules could be described for the arrangement in a network node, illustrated in FIG. 5. In FIG. 9 is illustrated an arrangement comprising a computer program product 908, in its turn comprising a computer program 910, comprising computer readable code modules, which when run in a network node causes the network node to determine whether a TTI Bundling setting of the UE should be changed from one state to the other of a state ON and a state OFF; and, when it is decided that the TTI Bundling setting of the UE should be changed, further causing the network node to transmit a message to the UE, indicating the decided change of TTI Bundling setting, and further as a consequence of the decision to change the TTI Bundling setting, and in association with the transmission of the message, to transmit mobility control information to the UE, indicating a target cell, in order to cause the UE to perform an intra-cell hand over procedure.

Although the code means in the embodiments disclosed above in conjunction with FIGS. 8 and 9 are implemented as computer program modules which when executed in the processing unit causes the arrangement and/or

UE/network node to perform the actions described above in the conjunction with figures mentioned above, at least one of the code means may in alternative embodiments be implemented at least partly as hardware circuits.

It is to be understood that the choice of interacting units or modules, as well as the naming of the units are only for exemplifying purpose, and client and server nodes suitable to execute any of the methods described above may be configured in a plurality of alternative ways in order to be able to execute the suggested process actions.

It should also be noted that the units or modules described in this disclosure are to be regarded as logical entities and not with necessity as separate physical entities.

Although the description above contains a plurality of specificities, these should not be construed as limiting the scope of the concept described herein but as merely providing illustrations of some exemplifying embodiments of the described concept. It will be appreciated that the scope of the presently described concept fully encompasses other embodiments which may become obvious to those skilled in the art, and that the scope of the presently described concept is accordingly not to be limited. Reference to an element in the singular is not intended to mean “one and only one” unless explicitly so stated, but rather “one or more.” All structural and functional equivalents to the elements of the above-described embodiments that are known to those of ordinary skill in the art are expressly incorporated herein by reference and are intended to be encompassed hereby. Moreover, it is not necessary for a device or method to address each and every problem sought to be solved by the presently described concept, for it to be encompassed hereby.

### ABBREVIATIONS

3GPP 3^{rd} Generation Partnership Project
CBRA Contention Based Random Access
CFRA Contention Free Random Access
C-RNTI Cell Radio Network Temporary Identifier
DL downlink
eNB eNodeB (A base station supporting LTE.)
GSM Global System for Mobile Communications
HSPA High Speed Packet Access
IE Information Element
MAC Medium Access Control
ms millisecond
UL-SCH Uplink Shared Channel
RA Random Access
RaMsg3 Random Access Message 3
RRC Radio Resource Control
SR Scheduling Request
TTI Transmission Time Interval
UE User Equipment
UL uplink

1-22. (canceled)

23. A method performed by a network node serving a User Equipment, UE, in a cell, said method comprising:
determining whether a transmission time interval, TTI, Bundling setting of the UE should be changed from one state to the other of a state ON and a state OFF; and
when it is decided that the TTI Bundling setting of the UE should be changed:
transmitting, a message to the UE, indicating the decided change of TTI Bundling setting; and
in association with the transmission of the message, transmitting mobility control information to the UE, indicating the cell as a target cell, to cause the UE to perform an intra-cell hand over procedure.

24. The method according to claim 23, further comprising verifying that the UE has initiated the intra-cell handover based on receiving a Random Access request from the UE in response to the transmission of the mobility control information.

25. The method according to claim 23, wherein transmitting the mobility control information comprises including the mobility control information in the message indicating the decided change of the TTI Bundling setting.

26. The method according to claim 23, wherein transmitting the message comprises transmitting an RRC Connection Reconfiguration Message.

27. The method according to claim 23, further comprising, in association with the mobility control information, transmitting a dedicated preamble to the UE, for use in a Random Access procedure towards the network node.

28. The method according to claim 23, further comprising, identifying the UE in a Random Access procedure performed by the UE towards the network node, based on at least one of:
a Cell Radio Network Temporary Identifier, C-RNTI, in a message received from the UE confirming the Random Access;
a C-RNTI in a message received from the UE, which message was granted by the network node in a response to the received Random Access request; and
a dedicated preamble received from the UE.

29. The method according to claim 23, further comprising retransmitting the message and mobility control information to the UE when a Random Access request has not been received from the UE within a defined time period from the latest transmission of the mobility control information.

30. A network node operable to serve a User Equipment, UE, in a cell, said network node comprising:
a communication transceiver configured for communicating with the UE; and
a processor circuit operatively associated with the communication transceiver and configured to:
determine whether a transmission time interval, TTI, Bundling setting of the UE should be changed from one state to the other of a state ON and a state OFF;
transmit a message to the UE when it is decided that the TTI Bundling setting of the UE should be changed, said message indicating the decided change of TTI Bundling setting; and
transmit mobility control information to the UE, as a consequence of the decision to change the TTI Bundling setting and in association with the transmission of the message, wherein the mobility control information indicates the cell as a target cell, to cause the UE to perform an intra-cell hand over procedure.

31. The network node according to claim 30, wherein the processing circuit is further configured to receive, via the communication transceiver, a Random Access request sent from the UE in response to the transmission of the mobility control information.

32. The network node according to claim 30, wherein the processing circuit is configured to include the mobility control information in the message indicating the decided change of TTI Bundling setting.

33. The network node according to claim 30, wherein the processing circuit is configured to transmit the message as an RRC Connection Reconfiguration Message.

34. The network node according to claim 30, wherein the processing circuit is configured to transmit, in association with the mobility control information, a dedicated preamble to the UE, for use by the UE in a Random Access procedure towards the network node.

35. The network node according to claim 30, wherein the processing circuit is configured to identify the UE in a Random Access procedure performed by the UE towards the network node, based on at least one of:
a Cell Radio Network Temporary Identifier, C-RNTI, in a message received from the UE confirming a Random Access;
a C-RNTI in a message received from the UE, which message was granted by the network node in a response to a received Random Access request from the UE; and
a dedicated preamble received from the UE.

36. The network node according to claim 30, wherein the processing circuit is configured to retransmit the message and mobility control information to the UE when a Random Access request has not been received from the UE within a defined time period from the latest transmission.

37. A method performed by a User Equipment, UE, served by a network node in a cell, the method comprising:
receiving a message from the network node indicating that a Transmission Time Interval, TTI, Bundling setting of the UE should be changed from one state to the other of a state ON and a state OFF;
determining whether mobility control information is received in association with the message, said mobility control information indicating the cell as target cell;
determining which type of Random Access to be used for a Random Access procedure towards the target cell; and
applying the changed TTI Bundling setting to transmissions to the network node in accordance with the determined Random Access procedure.

38. The method according to claim 37, further comprising:
when the determined type of Random Access is Contention Free, the step of applying involves one of:
not applying the changed TTI bundling on the UL-SCH transmission granted by a Random Access Response message from the network node, and then applying the new TTI bundling setting on subsequent transmissions; or
applying the changed TTI bundling setting on the UL-SCH transmission granted by a Random Access Response message from the network node.

39. A User Equipment, UE, operable to be served by a network node in a cell, the UE comprising:
a transceiver configured for communicating with the network node;
a processing circuit operatively associated with the transceiver and configured to:
receive a message from the network node indicating that a Transmission Time Interval, TTI, Bundling setting of the UE should be changed from one state to the other of a state ON and a state OFF;
determine whether mobility control information is received in association with the message, said mobility control information indicating the cell as a target cell;
determine which type of Random Access to be used for a Random Access procedure towards the target cell; and
apply the changed TTI Bundling setting to transmissions to the network node in accordance with the determined Random Access procedure.

40. The UE according to claim 39, wherein, with respect to applying the changed TTI Bundling setting to transmissions to the network node when the determined type of Random Access is Contention Free, the processing circuit is configured to do one of:
not apply the changed TTI bundling on the UL-SCH transmission granted by a Random Access Response message from the network node, and then apply the changed TTI bundling setting on subsequent transmissions; or
apply the changed TTI bundling setting on the UL-SCH transmission granted by a Random Access Response message from the network node.

41. A non-transitory computer-readable medium storing a computer program, comprising computer readable code modules that when executed on a processing circuit of a User Equipment, UE, configured for operation in a communication network, configures the UE to:
receive a message from the network node, indicating that a Transmission Time Interval, TTI, Bundling setting of the UE should be changed from one state to the other of a state ON and a state OFF;
determine whether mobility control information is received in association with the message, said mobility control information indicating a target cell;
determine which type of Random Access to use for a Random Access procedure towards the target cell; and
apply the changed TTI Bundling setting to transmissions to the network node in accordance with the determined Random Access procedure.

42. A non-transitory computer-readable medium storing a computer program, comprising computer readable code modules that, when executed on a processing circuit of a network node configured for operation in a communication network, configures the network node to:
determine whether a transmission time interval, TTI, Bundling setting of a User Equipment, UE, operating in the network should be changed from one state to the other of a state ON and a state OFF; and
when it is decided that the TTI Bundling setting of the UE should be changed, transmit, a message to the UE, indicating the decided change of TTI Bundling setting, and, in association with the transmission of the message, transmit mobility control information to the UE, indicating a target cell, in order to cause the UE to perform an intra-cell hand over procedure.
